(19) United States
(12) Patent Application Publication
(10) Pub. No.: US 2024/0209150 A1
(43) Pub. Date: Jun. 27, 2024

(54) PREPARATION METHOD OF A HIGH-ENTROPY COVALENT ORGANIC FRAMEWORK COMPOUND

(71) Applicant: China Three Gorges University, Yichang (CN)

(72) Inventors: Liqun YE, Yichang (CN); Qiao WANG, Yichang (CN)

(73) Assignee: China Three Gorges University, Yichang (CN)

(21) Appl. No.: 18/530,221

(22) Filed: Dec. 6, 2023

(30) Foreign Application Priority Data
Dec. 11, 2022 (CN) 202211584757.0

(51) Int. Cl. C08G 73/02

(52) U.S. Cl. CPC C08G 73/0206

(57) ABSTRACT

A preparation method of a high-entropy covalent organic framework compound (COF) is provided, specifically, at room temperature under ultrasonic conditions, trialdehyde phloroglucinol (Tp), 2,5-dibromo-p-phenylenediamine, 2,5-dichloro-p-phenylenediamine, 2-(trifluoromethyl)-1,4-phenylenediamine and p-phenylenediamine are dispersed in the mixed solution of o-dichlorobenzene and n-butanol; the appropriate amount of acetic acid and deionized water are added to the above solution after ultrasonic dispersion; and vacuuming for 5 min under liquid nitrogen freezing conditions, then thawing, so cycle 3 times, and then reacting in an oven at 120° C. for 72 h. The prepared samples are washed with dichloromethane, and the samples are collected in a vacuum oven at 80° C. overnight. The technical scheme of the present invention is to rapidly generate crystalline substances insoluble in solvents under the condition of acetic acid and to obtain COF materials with high crystallinity and high specific surface area through 3 days of high-temperature preparation.

### CROSS REFERENCE TO THE RELATED APPLICATIONS

This application is based upon and claims priority to Chinese Patent Application No. 202211584757.0, filed on Dec. 11, 2022, the entire contents of which are incorporated herein by reference.

### TECHNICAL FIELD

The present invention relates to a flame sealing tube method for preparing a high-entropy covalent organic framework compound, which belongs to the field of new materials and catalysis.

### BACKGROUND

As a new type of crystalline porous organic material, covalent organic framework (COF) can flexibly adjust the network structure of the material by adjusting the organic molecules connected by covalent bonds, so as to prepare a material with high crystallization, porous and high stability. At present, the preparation methods of covalent organic framework materials include a solvothermal method, a microwave heating method, an ionothermal synthesis method, a mechanochemical method and other chemical methods. In the solvothermal method, the reaction monomer and the suitable solvent are generally placed in the container, and the reactants are fully dispersed in the solvent by ultrasound. Finally, the sealed container tube is heated for a period of time to obtain a solid powder, and then washing it with the solvent, vacuum dried, and finally the purpose product is obtained.

In 2004, Professor Ye Junwei first proposed the concept of ‘high entropy alloy’, which provides a new idea for the synthesis of alloy materials. Different from traditional alloys, high-entropy alloys, as a new type of alloy, are usually composed of five or more elements in equal atomic ratio or near equal atomic ratio, and the content of each element is 5-35%. Inspired by the above research, this study uses trialdehyde phloroglucinol(Tp), 2,5-dibromo-p-phenylenediamine, 2,5-dichloro-p-phenylenediamine, 2-(trifluoromethyl)-1,4-phenylenediamine, p-phenylenediamine, five monomers are quickly sealed in a customized glass tube by a flame gun in a short time according to the aldehyde:amino molar ratio of 1-5:1 in a customized glass tube, and then prepared by solvothermal synthesis. However, the traditional container, after many times of repeated, the sealing of the container is greatly reduced, and the crystallinity of the material is also affected. The synthesis method used in this study can greatly reduce the decrease of crystallinity because it is a customized disposable glass tube. At present, the study of covalent organic frameworks often involves the Schiff base reaction of two monomers, in this invention, five COF monomers are reacted to obtain a high-entropy covalent organic framework compound, which further broadened the preparation idea of the covalent organic framework.

### SUMMARY

In view of this, the present invention mixes five different monomers together, selects the appropriate solvent, and successfully prepares a high-entropy covalent organic framework compound by flame sealing tube technology, and the prepared materials have high crystallinity. The product of the present invention is prepared by mixing five monomers according to the ratio of aldehyde group to amino group.

A high-entropy covalent organic framework compound, wherein a structural formula of the high-entropy covalent organic framework compound is selected from one of the following formulas:

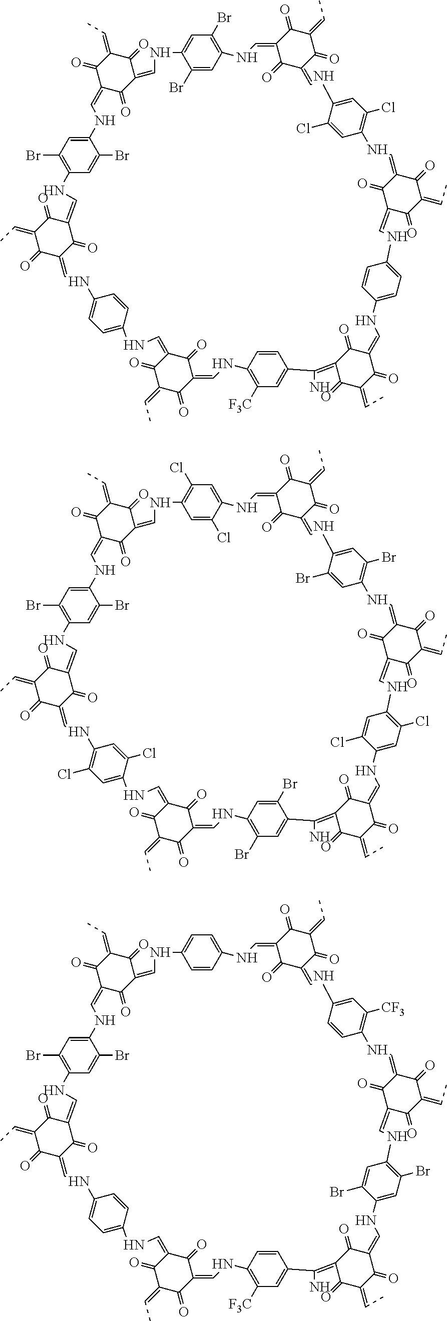

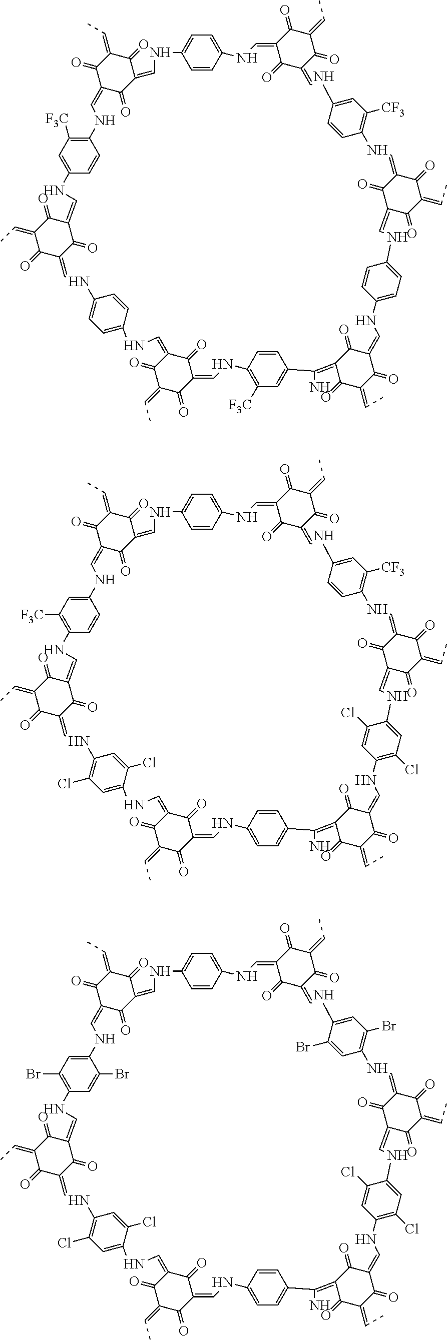

In an X-ray powder diffraction pattern of the high-entropy covalent organic framework compound, 2θ of the high-entropy covalent organic framework compound includes characteristic peaks at 2.88°±0.1, 5°±0.1, 5.7°±0.1, 7.5°±0.1, 10°±0.1, 25°±0.1, corresponding to (100), (110), (200), (210), (220), (001) crystal planes.

Another technical solution of the present invention is to provide a preparation method of the high-entropy covalent organic framework compound, and the preparation method is as follows:
(1) adding 1,3,5-trialdehyde phloroglucinol and phenylenediamine monomers to a reactor, adding a solvent , and performing an ultrasound treatment to make a powder of the trialdehyde phloroglucinol and the phenylenediamine monomers fully dispersed in the solvent;
(2) vacuuming the sample in step (1) in a liquid nitrogen atmosphere, and vacuum flame sealing the reactor under a condition of vacuuming, then reacting at 80° C.-150° C. for 1-7 d. In this step, exhausting excess air in the glass tube by a vacuum pump, making the material be synthesized under vacuum conditions to improve the crystallinity of the COF material. Then sealing completely a customized flame tube with a flame gun (methane), when the glass tube is restored to room temperature, putting into an oven at 80° C.-150° C. for 1-7 d, and a relatively long time of high temperature contributes to the slow formation of crystals.

The phenylenediamine monomers described in step (1) are 2,5-dibromo-p-phenylenediamine, 2,5-dichloro-p-phenylenediamine, 2-(trifluoromethyl)-1,4-phenylenediamine and para-phenylenediamine;
a molar ratio of aldehyde group to amino group is controlled at (1-5):1 in 1,3,5-trialdehyde phloroglucinol and phenylenediamine monomers; and
a molar ratio of each raw material 2,5-dibromo-p-phenylenediamine, 2,5-dichloro-p-phenylenediamine, 2-(trifluoromethyl)-1,4-phenylenediamine, para-phenylenediamine of the phenylenediamine monomers is (1-2):(1-2):(1-2):(1-2).

As a preferred scheme, wherein a molar ratio of each of the five monomers of the 1,3,5-trialdehyde phloroglucinol, 2,5-dibromo-p-phenylenediamine, 2,5-dichloro-p-phenylenediamine, 2-(trifluoromethyl)-1,4-phenylenediamine and para-phenylenediamine is 8-40:3:3:3:3.

The solvent described in step (1) is a mixed solvent formed by o-dichlorobenzene and any alcohol of C1-C5, and the volume ratio of o-dichlorobenzene to any alcohol of C1-C5 is 1:(0.5-5).

As a preferred scheme, wherein the alcohols include any of methanol, ethanol, isopropanol, propanol, butanol, 2-butanol, n-pentanol, and isoamyl alcohol.

In step (1), a concentration of each of the five monomers of the trialdehyde phloroglucinol, 2,5-dibromo-p-phenylenediamine, 2,5-dichloro-p-phenylenediamine, 2-(trifluoromethyl)-1,4-phenylenediamine and para-phenylenediamine is 0.01 mmol/mL-0.1 mmol/mL.

In step (1), the concentration of each of the five monomers of the trialdehyde phloroglucinol, 2,5-dibromo-p-phenylenediamine, 2,5-dichloro-p-phenylenediamine, 2-(trifluoromethyl)-1,4-phenylenediamine and para-phenylenediamine is 0.03 mmol/mL-0.04 mmol/mL.

In step (2), a pH of the sample is adjusted by the acetic acid solution before vacuuming in a liquid nitrogen atmosphere; a mass concentration of the acetic acid solution is 10-30%, a pH range is 2.26-2.02, after adding acetic acid, some insoluble substances will be quickly formed, and the polymerization state of the target product will be initially formed.

As a preferred scheme, the mass concentration of the acetic acid solution is 18%, the pH condition is 2.13, and then the above solution is ultrasonically dispersed to promote the uniform dispersion of the acetic acid solution.

The samples in step (2) are frozen-thawed several times before vacuum flame sealing.

The preparation of the high-entropy covalent organic framework compound of the present invention utilizes the acidity of acetic acid to initially accelerate the formation of the polymerization state of the material; and it ensures that the reaction environment is under vacuum conditions, and uses the high temperature hydrothermal method to promote the crystal to be slowly shaped again.

### BRIEF DESCRIPTION OF THE DRAWINGS

FIGS. 1A-1C show a high-entropy COF prepared by Example 1, wherein FIG. 1A: 10,000 times SEM image, FIG. 1B: 50,000 times SEM image. FIG. 1C: high-entropy COF water splitting hydrogen image.

FIG. 2 is an XRD image of high-entropy COF prepared by Example 1.

FIG. 3 is an XRD image of high-entropy COF prepared by Example 2.

FIG. 4 is an XRD image of high-entropy COF prepared by Example 3.

FIG. 5 is an XRD image of high-entropy COF prepared by Example 4.

FIG. 6 is an XRD image of high-entropy COF prepared by Example 5.

FIG. 7 is an XRD image of high-entropy COF prepared by Example 6.

FIG. 8 is an XRD image of high-entropy COF prepared by Example 7.

FIG. 9 is an XRD image of COF-1 prepared by Example 8.

FIG. 10 is an XRD image of COF-2 prepared by Example 9.

FIG. 11 is an XRD image of COF-3 prepared by Example 10.

FIG. 12 is an XRD image of COF-4 prepared by Example 11.

FIG. 13 is an XRD image of COF-5 prepared by Example 12.

FIG. 14 is an XRD image of high-entropy COF prepared by Example 13.

FIG. 15 is an XRD image of high-entropy COF prepared by Example 14.

### DETAILED DESCRIPTION OF THE EMBODIMENTS

### Example 1

At room temperature, trialdehyde phloroglucinol (Tp), 2,5-dibromo-p-phenylenediamine, 2,5-dichloro-p-phenylenediamine, 2-(trifluoromethyl)-1,4-phenylenediamine and para-phenylenediamine are added to a custom-made 10 ml glass tube at a molar ratio of 8:3:3:3:3, respectively. Then o-dichlorobenzene: n-butanol=1:1 is added to the glass tube, completely covering the bottle mouth with sealing film, and ultrasonic until the sample is fully dispersed in the solvent. After that, acetic acid and pure water are added again, the volume ratio of o-dichlorobenzene: n-butanol: acetic acid: deionized water is 15:15:2:4, and the ultrasonic time is half an hour, then insoluble powder appears. After that, the above solution is frozen-thawed in liquid nitrogen, meanwhile continuously vacuumed, and cycled 3 times, quickly sealing the glass tube with a flame gun, after the solution temperature returned to room temperature, put into an oven at 120° C.for 3 days. Then the samples after the reaction are washed with dichloromethane and acetone in turn, put in a vacuum oven at 80° C., dried overnight, and collected samples with agate mortar, and the product structure is as follows:

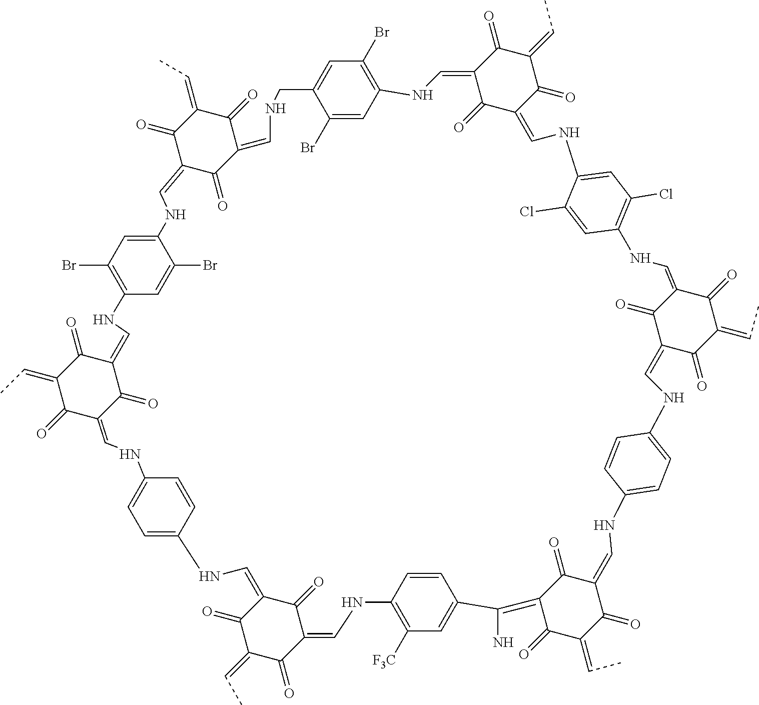

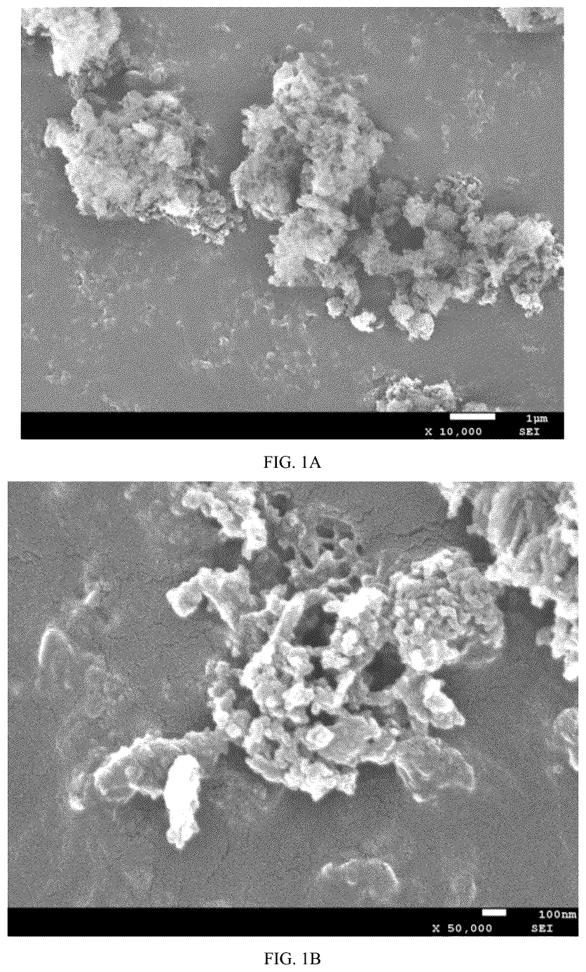

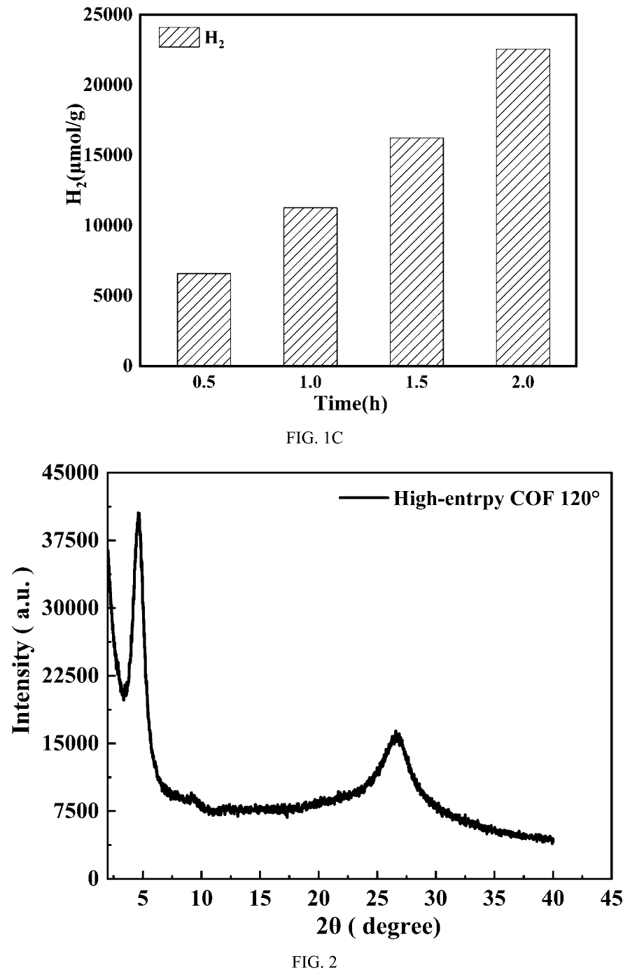

FIGS. 1A-1C and FIG. 2 are the SEM images and XRD images of the high-entropy covalent organic framework compound prepared in Example 1, as shown in images (a) and (b), it can be seen from the figures that the morphology of the material is agglomerated, and the peak of the XRD pattern is higher at 2°-5°, indicating that the crystallinity of the sample is higher.

### Example 2

At room temperature, trialdehyde phloroglucinol (Tp), 2,5-dibromo-p-phenylenediamine, 2,5-dichloro-p-phenylenediamine, 2-(trifluoromethyl)-1,4-phenylenediamine and para-phenylenediamine are added to a custom-made 10 ml glass tube at a molar ratio of 8:3:3:3:3, respectively. Then o-dichlorobenzene: n-butanol=1:1 is added to the glass tube, completely covering the bottle mouth with sealing film, and ultrasonic until the sample is fully dispersed in the solvent. After that, acetic acid and pure water are added again, the volume ratio of o-dichlorobenzene: n-butanol: acetic acid: deionized water is 15:15:2:4, and the ultrasonic time is half an hour, then insoluble powder appears. After that, the above solution is frozen-thawed in liquid nitrogen, meanwhile continuously vacuumed, and cycled 3 times, quickly sealing the glass tube with a flame gun, after the solution temperature returned to room temperature, put into an oven at 80° C. for 3 days. Then the samples after the reaction are washed with dichloromethane and acetone in turn, put in a vacuum oven at 80° C., dried overnight, and collected samples with agate mortar, and the product structure is as follows:

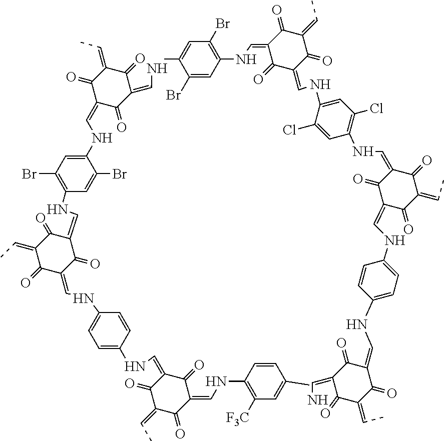

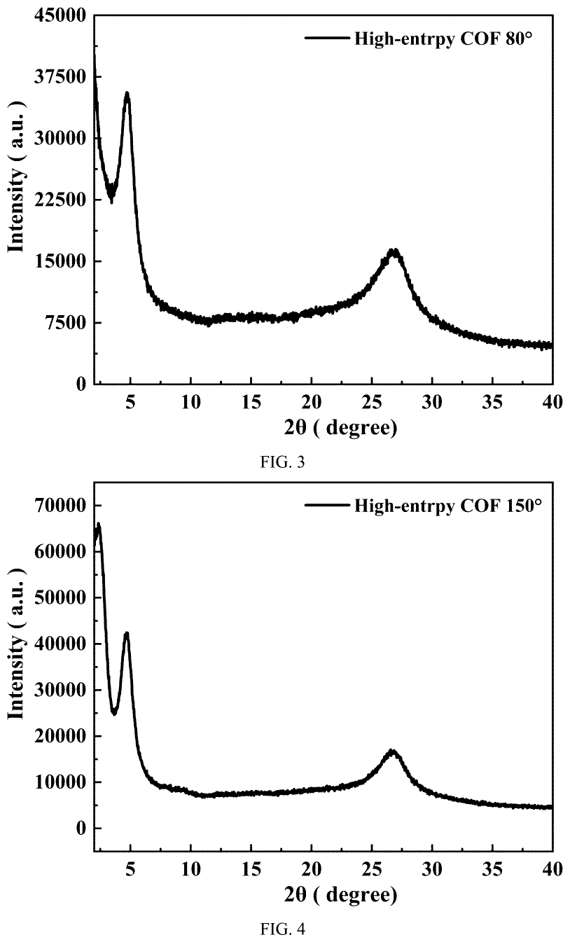

FIG. 3 is an XRD image of the high-entropy covalent organic framework compound at 80° C. prepared in Example 2, compared with 120° C., the intensity of the diffraction peak at 2-5° decreases, and the crystallinity decreases.

### Example 3

At room temperature, trialdehyde phloroglucinol (Tp), 2,5-dibromo-p-phenylenediamine, 2,5-dichloro-p-phenylenediamine, 2-(trifluoromethyl)-1,4-phenylenediamine and para-phenylenediamine are added to a custom-made 10 ml glass tube at a molar ratio of 40:3:3:3:3, respectively. Then o-dichlorobenzene: n-butanol=1:1 is added to the glass tube, completely covering the bottle mouth with sealing film, and ultrasonic until the sample is fully dispersed in the solvent. After that, acetic acid and deionized water are added again, the volume ratio of o-dichlorobenzene: n-butanol: acetic acid: deionized water is 15:15:2:4, and the ultrasonic time is half an hour, then insoluble powder appears. After that, the above solution is frozen-thawed in liquid nitrogen, meanwhile continuously vacuumed, and cycled 3 times, quickly sealing the glass tube with a flame gun, after the solution temperature returned to room temperature, put into an oven at 150° C. for 3 days. Then the samples after the reaction are washed with dichloromethane and acetone in turn, put in a vacuum oven at 80° C., dried overnight, and collected samples with agate mortar, and the product structure is as follows:

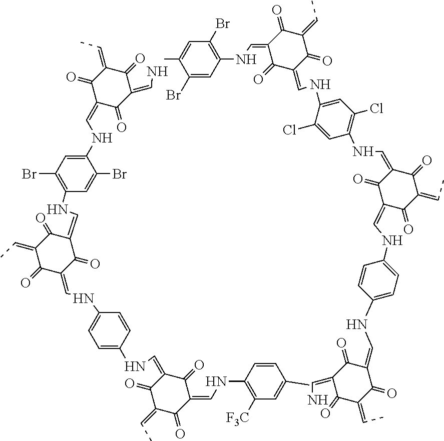

FIG. 4 is an XRD image of the high-entropy covalent organic framework compound at 150° C. prepared in Example 3, the peak intensity around 25°-30° is increased, indicating that the interlayer spacing of COF material is increased.

### Example 4

### Change of Solvent

At room temperature, trialdehyde phloroglucinol (Tp), 2,5-dibromo-p-phenylenediamine, 2,5-dichloro-p-phenylenediamine, 2-(trifluoromethyl)-1,4-phenylenediamine and para-phenylenediamine are added to a custom-made 10 ml glass tube at a molar ratio of 40:3:3:3:3, respectively. Then mesitylene:dioxane=1:1 is added to the glass tube, completely covering the bottle mouth with sealing film, and ultrasonic until the sample is fully dispersed in the solvent. After that, acetic acid and deionized water are added again, the volume ratio of mesitylene:dioxane:acetic acid:deionized water is 15:15:2:4, and the ultrasonic time is half an hour, then insoluble powder appears. After that, the above solution is frozen-thawed in liquid nitrogen, meanwhile continuously vacuumed, and cycled 3 times, quickly sealing the glass tube with a flame gun, after the solution temperature returned to room temperature, put into an oven at 120° C. for 3 days. Then the samples after the reaction are washed with dichloromethane and acetone in turn, put in a vacuum oven at 80° C., dried overnight, and collected samples with agate mortar, and the product structure is as follows:

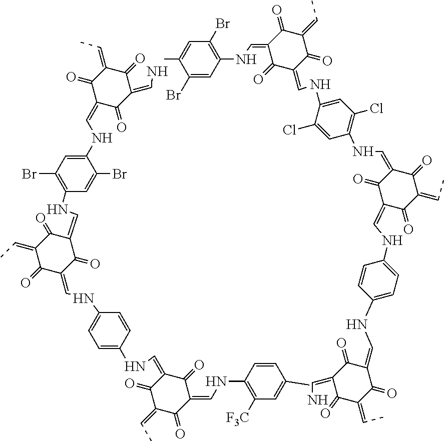

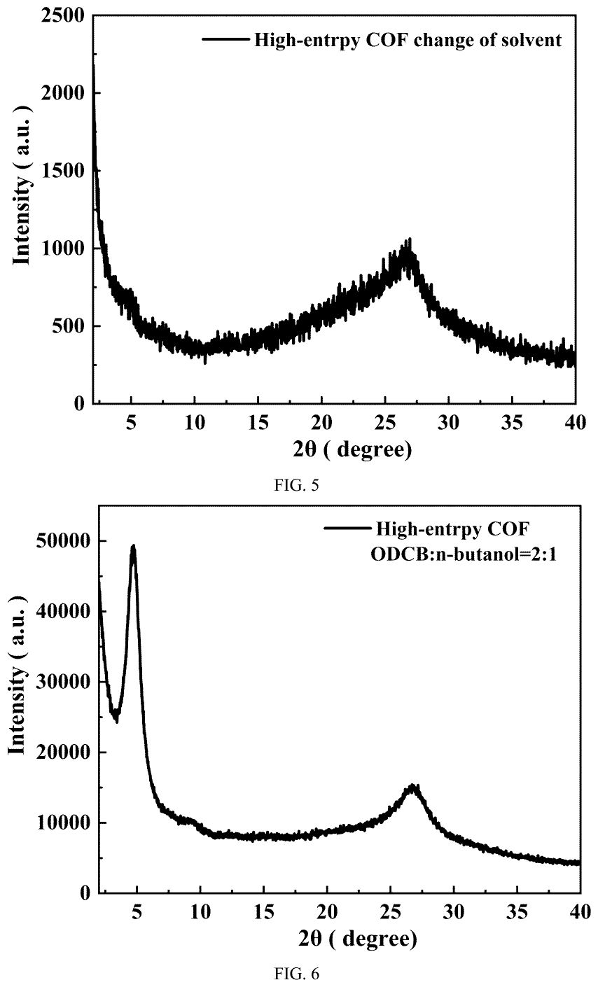

FIG. 5 is an XRD image of the high-entropy covalent organic framework compound prepared in Example 4 by changing the solvent to mesitylene and dioxane, and the results show that the material is non-crystalline state after changing the solvent.

### Example 5

At room temperature, trialdehyde phloroglucinol (Tp), 2,5-dibromo-p-phenylenediamine, 2,5-dichloro-p-phenylenediamine, 2-(trifluoromethyl)-1,4-phenylenediamine and para-phenylenediamine are added to a custom-made 10 ml glass tube at a molar ratio of 40:3:3:3:3, respectively. Then o-dichlorobenzene:n-butanol=2:1 is added to the glass tube, completely covering the bottle mouth with sealing film, and ultrasonic until the sample is fully dispersed in the solvent. After that, acetic acid and deionized water are added again, the volume ratio of o-dichlorobenzene:n-butanol:acetic acid:deionized water is 30:15:2:4, and the ultrasonic time is half an hour, then insoluble powder appears. After that, the above solution is frozen-thawed in liquid nitrogen, meanwhile continuously vacuumed, and cycled 3 times, quickly sealing the glass tube with a flame gun, after the solution temperature returned to room temperature, put into an oven at 120° C. for 3 days. Then the samples after the reaction are washed with dichloromethane and acetone in turn, put in a vacuum oven at 80° C., dried overnight, and collected samples with agate mortar, and the product structure is as follows:

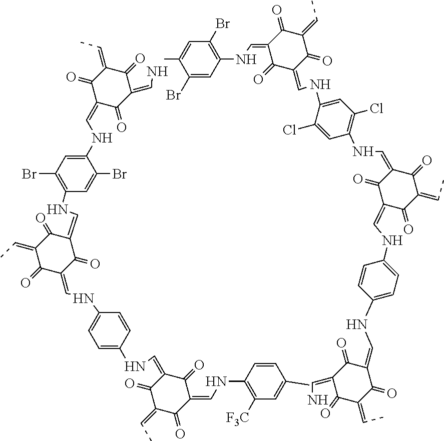

FIG. 6 is an XRD image obtained by changing the solvent to o-dichlorobenzene:n-butanol volume ratio of 2:1 for the high-entropy covalent organic framework compound prepared in Example 5, and the material still has a higher crystallinity.

### Example 6

At room temperature, trialdehyde phloroglucinol (Tp), 2,5-dibromo-p-phenylenediamine, 2,5-dichloro-p-phenylenediamine, 2-(trifluoromethyl)-1,4-phenylenediamine and para-phenylenediamine are added to a custom-made 10 ml glass tube at a molar ratio of 40:3:3:3:3, respectively. Then o-dichlorobenzene:n-butanol=1:2 is added to the glass tube, completely covering the bottle mouth with sealing film, and ultrasonic until the sample is fully dispersed in the solvent. After that, acetic acid and deionized water are added again, the volume ratio of o-dichlorobenzene:n-butanol:acetic acid:deionized water is 15:30:2:4, and the ultrasonic time is half an hour, then insoluble powder appears. After that, the above solution is frozen-thawed in liquid nitrogen, meanwhile continuously vacuumed, and cycled 3 times, quickly sealing the glass tube with a flame gun, after the solution temperature returned to room temperature, put into an oven at 120° C. for 3 days. Then the samples after the reaction are washed with dichloromethane and acetone in turn, put in a vacuum oven at 80° C., dried overnight, and collected samples with agate mortar, and the product structure is as follows:

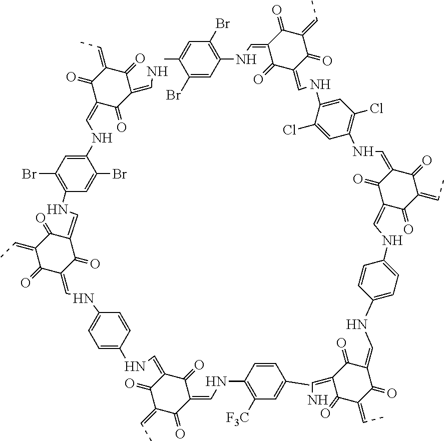

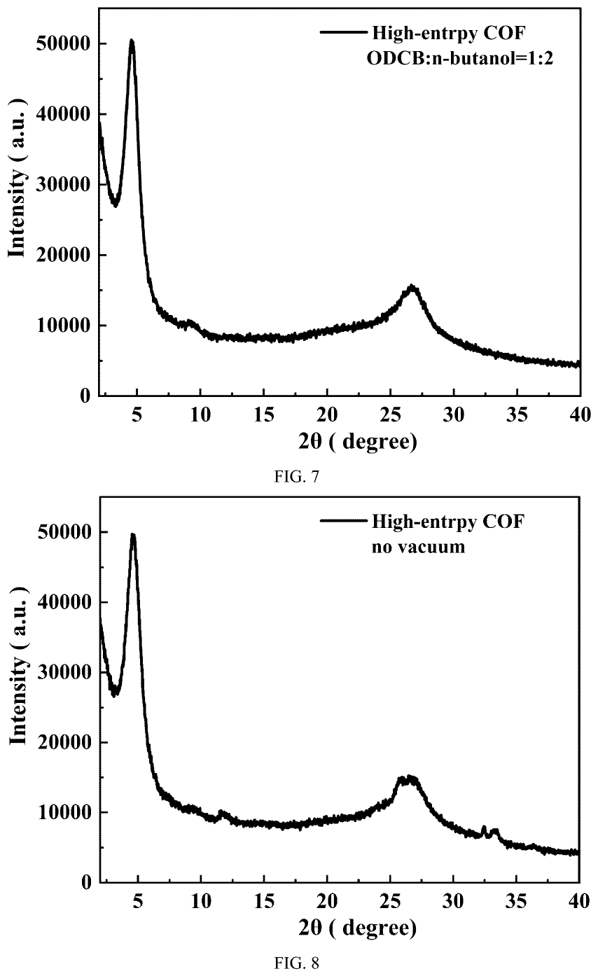

FIG. 7 is an XRD image of the high-entropy covalent organic framework compound prepared in Example 6 by changing the solvent to o-dichlorobenzene: n-butanol volume ratio of 1:2.

### Example 7

### No Vacuum

At room temperature, trialdehyde phloroglucinol (Tp), 2,5-dibromo-p-phenylenediamine, 2,5-dichloro-p-phenylenediamine, 2-(trifluoromethyl)-1,4-phenylenediamine and para-phenylenediamine are added to a custom-made 10 ml glass tube at a molar ratio of 40:3:3:3:3, respectively. Then o-dichlorobenzene:n-butanol=1:1 is added to the glass tube, completely covering the bottle mouth with sealing film, and ultrasonic until the sample is fully dispersed in the solvent. After that, acetic acid and deionized water are added again, the volume ratio of o-dichlorobenzene:n-butanol:acetic acid:deionized water is 15:15:2:4, and the ultrasonic time is half an hour, then insoluble powder appears, quickly sealing the glass tube with a flame gun, after the solution temperature returned to room temperature, put into an oven at 120° C. for 3 days. Then the samples after the reaction are washed with dichloromethane and acetone in turn, put in a vacuum oven at 80° C., dried overnight, and collected samples with agate mortar, and the product structure is as follows:

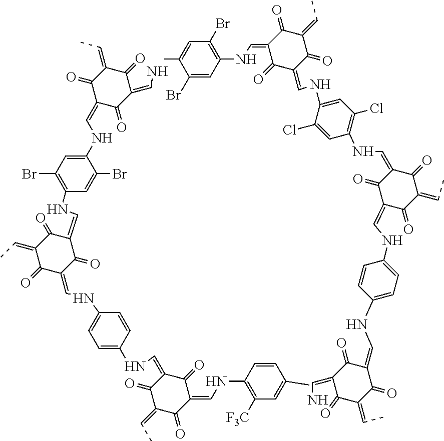

FIG. 8 is an XRD image of the high-entropy covalent organic framework compound prepared in Example 7 without vacuum, and the results show that the material has a peak at 30°-35°.

### Example 8

At room temperature, trialdehyde phloroglucinol (Tp), 2,5-dibromo-p-phenylenediamine and 2,5-dichloro-p-phenylenediamin are added to a custom-made 10 ml glass tube at a molar ratio of 4:3:3, respectively. Then o-dichlorobenzene:n-butanol=1:2 is added to the glass tube, completely covering the bottle mouth with sealing film, and ultrasonic until the sample is fully dispersed in the solvent. After that, acetic acid and deionized water are added again, the volume ratio of o-dichlorobenzene:n-butanol:acetic acid:deionized water is 15:15:2:4, and the ultrasonic time is half an hour, then insoluble powder appears, After that, the above solution is frozen-thawed in liquid nitrogen, meanwhile continuously vacuumed, and cycled 3 times, quickly sealing the glass tube with a flame gun, after the solution temperature returned to room temperature, put into an oven at 120° C.for 3 days. Then the samples after the reaction are washed with dichloromethane and acetone in turn, put in a vacuum oven at 80° C., dried overnight, and collected samples with agate mortar, the material is named COF-1, and the product structure is as follows:

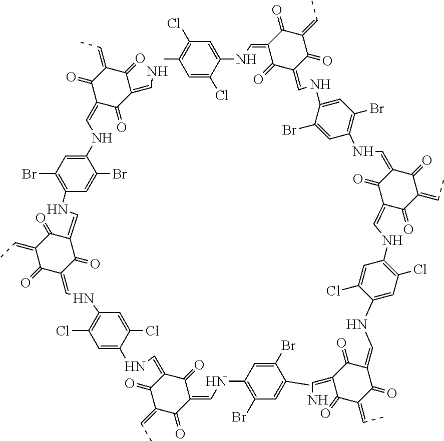

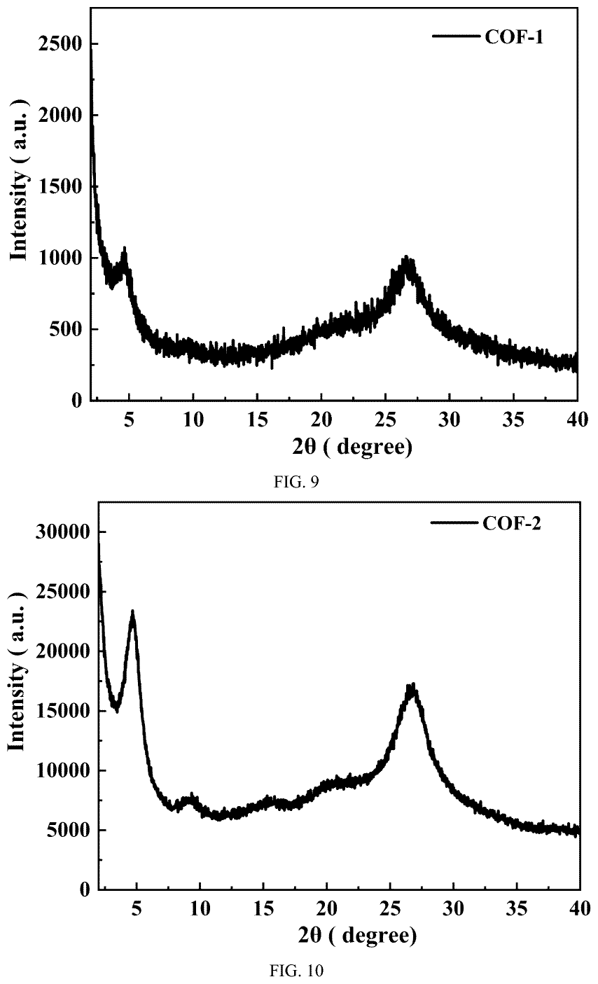

FIG. 9 is an XRD image of COF-1 prepared by trialdehyde phloroglucinol (Tp), 2,5-dibromo-p-phenylenediamine and 2,5-dichloro-p-phenylenediamine in Example 8, and the peak value of the material at 2°-5° is not obvious, indicating that the material has a low degree of crystallization.

### Example 9

At room temperature, trialdehyde phloroglucinol (Tp), 2,5-dibromo-p-phenylenediamine, 2-(trifluoromethyl)-1,4-phenylenediamine and para-phenylenediamine are added to a custom-made 10 ml glass tube at a molar ratio of 2:1:1:1, respectively. Then o-dichlorobenzene:n-butanol=1:1 is added to the glass tube, completely covering the bottle mouth with sealing film, and ultrasonic until the sample is fully dispersed in the solvent. After that, acetic acid and deionized water are added again, the volume ratio of o-dichlorobenzene:n-butanol:acetic acid:deionized water is 15:15:2:4, and the ultrasonic time is half an hour, then insoluble powder appears. After that, the above solution is frozen-thawed in liquid nitrogen, meanwhile continuously vacuumed, and cycled 3 times, quickly sealing the glass tube with a flame gun, after the solution temperature returned to room temperature, put into an oven at 150° C.for 3 days. Then the samples after the reaction are washed with dichloromethane and acetone in turn, put in a vacuum oven at 80° C., dried overnight, and collected samples with agate mortar, the material is named COF-2, and the product structure is as follows:

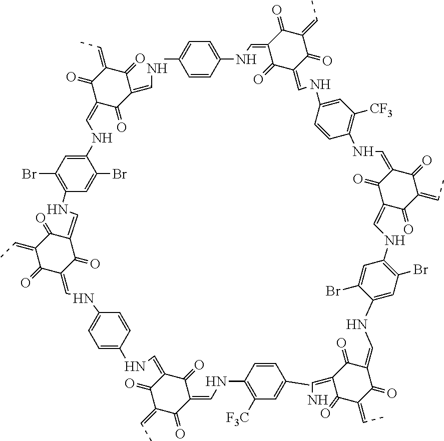

FIG. 10 is an XRD image of COF-2 prepared by trialdehyde phloroglucinol (Tp), 2,5-dibromo-p-phenylenediamine, 2-(trifluoromethyl)-1,4-phenylenediamine and para-phenylenediamine in Example 9, some impurity peaks appear at 10°-20°, and the peak intensity increases sharply at about 25°-30°, indicating that the crystallization degree of the material is not perfect.

### Example 10

At room temperature, trialdehyde phloroglucinol (Tp), 2-(trifluoromethyl)-1,4-phenylenediamine and para-phenylenediamine are added to a custom-made 10 ml glass tube at a molar ratio of 4:3:3, respectively. Then o-dichlorobenzene:n-butanol=1:1 is added to the glass tube, completely covering the bottle mouth with sealing film, and ultrasonic until the sample is fully dispersed in the solvent. After that, acetic acid and deionized water are added again, the volume ratio of o-dichlorobenzene:n-butanol:acetic acid:deionized water is 15:15:2:4, and the ultrasonic time is half an hour, then insoluble powder appears. After that, the above solution is frozen-thawed in liquid nitrogen, meanwhile continuously vacuumed, and cycled 3 times, quickly sealing the glass tube with a flame gun, after the solution temperature returned to room temperature, put into an oven at 150° C. for 3 days. Then the samples after the reaction are washed with dichloromethane and acetone in turn, put in a vacuum oven at 80° C., dried overnight, and collected samples with agate mortar, the material is named COF-3, and the product structure is as follows:

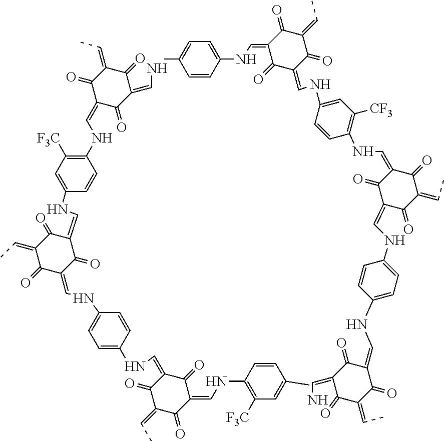

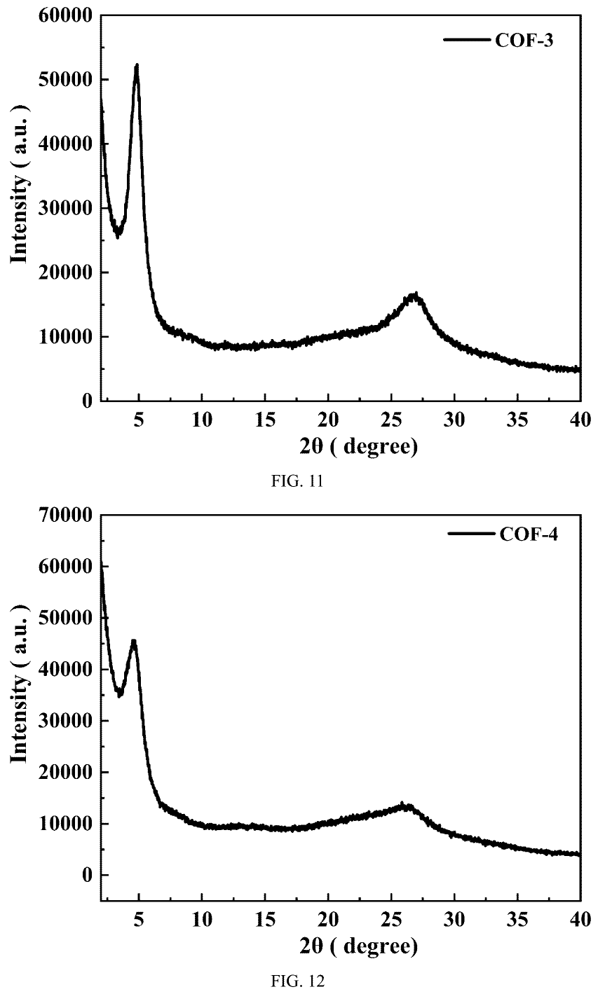

FIG. 11 is an XRD image of COF-3 prepared by trialdehyde phloroglucinol (Tp), 2-(trifluoromethyl)-1,4-phenylenediamine and para-phenylenediamine in Example 10, and the peak intensity around 2°-5° is higher, indicating the crystallization of COF material is better.

### Example 11

At room temperature, trialdehyde phloroglucinol (Tp), 2,5-dichloro-p-phenylenediamine, 2-(trifluoromethyl)-1,4-phenylenediamine and para-phenylenediamine are added to a custom-made 10 ml glass tube at a molar ratio of 2:1:1:1, respectively. Then o-dichlorobenzene:n-butanol=1:1 is added to the glass tube, completely covering the bottle mouth with sealing film, and ultrasonic until the sample is fully dispersed in the solvent. After that, acetic acid and deionized water are added again, the volume ratio of o-dichlorobenzene:n-butanol:acetic acid:deionized water is 15:15:2:4, and the ultrasonic time is half an hour, then insoluble powder appears. After that, the above solution is frozen-thawed in liquid nitrogen, meanwhile continuously vacuumed, and cycled 3 times, quickly sealing the glass tube with a flame gun, after the solution temperature returned to room temperature, put into an oven at 150° C.for 3 days. Then the samples after the reaction are washed with dichloromethane and acetone in turn, put in a vacuum oven at 80° C., dried overnight, and collected samples with agate mortar, the material is named COF-4, and the product structure is as follow:

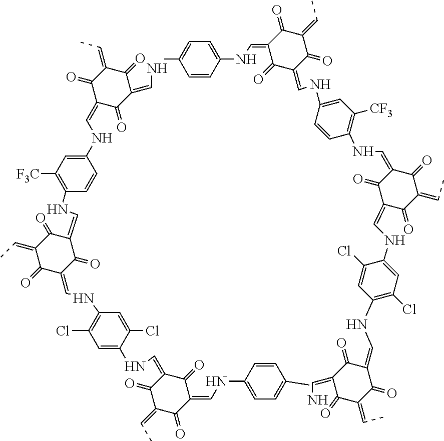

FIG. 12 is an XRD image of COF-4 prepared with trialdehyde phloroglucinol (Tp), 2,5-dichloro-p-phenylenediamine, 2-(trifluoromethyl)-1,4-phenylenediamine and para-phenylenediamine in Example 11, the peak intensity of 2°-5° is higher, indicating that the crystallinity of COF material is better.

### Example 12

At room temperature, trialdehyde phloroglucinol (Tp), 2,5-dibromo-p-phenylenediamine, 2,5-dichloro-p-phenylenediamine and para-phenylenediamine are added to a custom-made 10 ml glass tube at a molar ratio of 2:1:1:1, respectively. Then o-dichlorobenzene:n-butanol=1:1 is added to the glass tube, completely covering the bottle mouth with sealing film, and ultrasonic until the sample is fully dispersed in the solvent. After that, acetic acid and pure water are added again, the volume ratio of o-dichlorobenzene:n-butanol:acetic acid:deionized water is 15:15:2:4, and the ultrasonic time is half an hour, then insoluble powder appears. After that, the above solution is frozen-thawed in liquid nitrogen, meanwhile continuously vacuumed, and cycled 3 times, quickly sealing the glass tube with a flame gun, after the solution temperature returned to room temperature, put into an oven at 120° C. for 3 days. Then the samples after the reaction are washed with dichloromethane and acetone in turn, put in a vacuum oven at 80° C., dried overnight, and collected samples with agate mortar, the material is named COF-5, and the product structure is as follows:

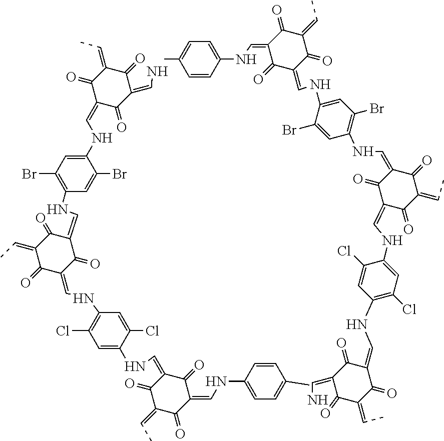

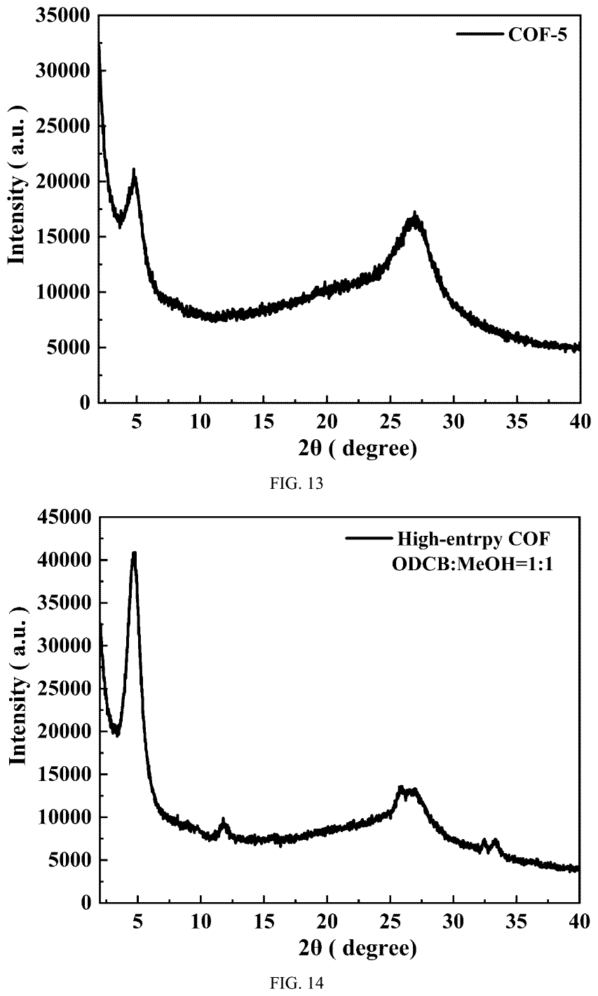

FIG. 13 is an XRD image of COF-5 prepared with aldehyde phloroglucinol (Tp), 2,5-dibromo-p-phenylenediamine, 2,5-dichloro-p-phenylenediamine and para-phenylenediamine in Example 12, the peak value at 25°-30° is larger, indicating that the material layer spacing is larger.

### Example 13

At room temperature, trialdehyde phloroglucinol (Tp), 2,5-dibromo-p-phenylenediamine, 2,5-dichloro-p-phenylenediamine, 2-(trifluoromethyl)-1,4-phenylenediamine and para-phenylenediamine are added to a custom-made 10 ml glass tube at a molar ratio of 8:3:3:3:3, respectively. Then o-dichlorobenzene:methanol=1:1 is added to the glass tube, completely covering the bottle mouth with sealing film, and ultrasonic until the sample is fully dispersed in the solvent. After that, acetic acid and pure water are added again, the volume ratio of o-dichlorobenzene:methanol:acetic acid:deionized water is 15:15:2:4, and the ultrasonic time is half an hour, then insoluble powder appears. After that, the above solution is frozen-thawed in liquid nitrogen, meanwhile continuously vacuumed, and cycled 3 times, quickly sealing the glass tube with a flame gun, after the solution temperature returned to room temperature, put into an oven at 120° C.for 3 days. Then the samples after reaction are washed with dichloromethane and acetone in turn, put in a vacuum oven at 80° C., dried overnight, and collected samples with agate mortar, the product structure is as follows:

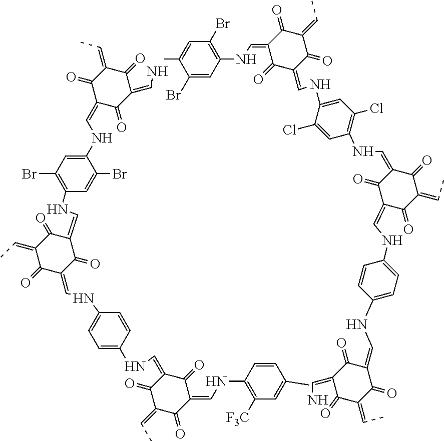

FIG. 14 is an XRD image of the high-entropy covalent organic framework compound prepared in Example 13 after changing the solvent into methanol, and the sample still has a higher peak at 2°-5°, indicating that the crystallinity of the material is higher, however, there are many impurity peaks in the sample at 10°-35°, indicating that the material synthesis contains more impurities.

### Example 14

At room temperature, trialdehyde phloroglucinol (Tp), 2,5-dibromo-p-phenylenediamine, 2,5-dichloro-p-phenylenediamine, 2-(trifluoromethyl)-1,4-phenylenediamine and para-phenylenediamine are added to a custom-made 10 ml glass tube at a molar ratio of 8:3:3:3:3, respectively. Then o-dichlorobenzene:n-butanol=1:1 is added to the glass tube, completely covering the bottle mouth with sealing film, and ultrasonic until the sample is fully dispersed in the solvent. After that, the acetic acid solution is added again, the PH of acetic acid is 2.26, the volume ratio of o-dichlorobenzene:n-butanol:acetic acid:deionized water is 15:15:2:4, and the ultrasonic time is half an hour, then insoluble powder appears. After that, the above solution is frozen-thawed in liquid nitrogen, meanwhile continuously vacuumed, and cycled 3 times, quickly sealing the glass tube with a flame gun, after the solution temperature returned to room temperature, put into an oven at 120° C. for 3 days. Then the samples after reaction are washed with dichloromethane and acetone in turn, put in a vacuum oven at 80° C., dried overnight, and collected samples with agate mortar, and the product structure is as follows:

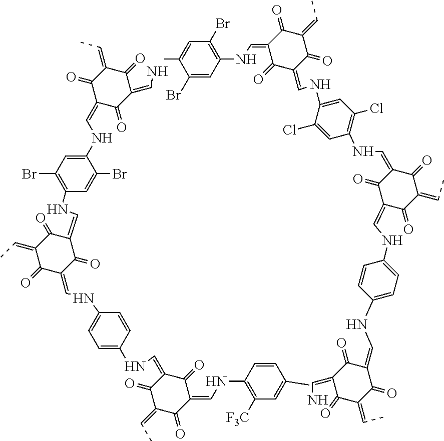

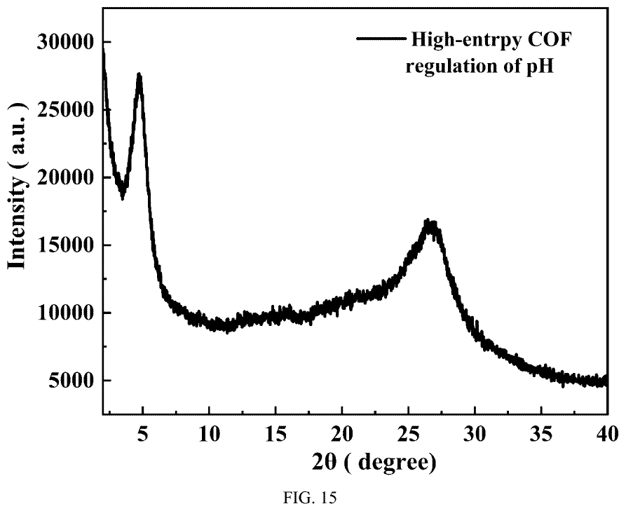

FIG. 15 is an XRD image of the high-entropy covalent organic framework compound prepared by changing the pH value of acetic acid in Example 14, it is shown that the peak value of the material increases from 25° to 30°, and it shows that changing the PH value of the acetic acid solution has an effect on the layer spacing of the material.

### Example 15

At room temperature, trialdehyde phloroglucinol (Tp), 2,5-dibromo-p-phenylenediamine, 2,5-dichloro-p-phenylenediamine, 2-(trifluoromethyl)-1,4-phenylenediamine and para-phenylenediamine are added to a custom-made 10 ml glass tube at a molar ratio of 8:3:3:3:3, respectively. Then o-dichlorobenzene:n-butanol=1:1 is added to the glass tube, completely covering the bottle mouth with sealing film, and ultrasonic until the sample is fully dispersed in the solvent. After that, acetic acid and pure water are added again, the volume ratio of o-dichlorobenzene:n-butanol:acetic acid:deionized water is 15:15:2:4, and the ultrasonic time is half an hour, then insoluble powder appears. After that, the above solution is frozen-thawed in liquid nitrogen, meanwhile continuously vacuumed, and cycled 3 times, quickly sealing the glass tube with a flame gun, after the solution temperature returned to room temperature, put into an oven at 120° C.for 3 days. Then the samples after reaction are washed with dichloromethane and acetone in turn, put in a vacuum oven at 80° C., dried overnight, and collected samples with agate mortar, and the product structure is as follows:

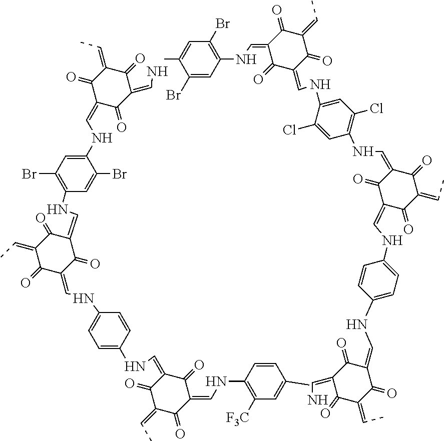

The collected high-entropy COF50 mg and deionized water 100 mL are weighed, adding 160 μL of chloroplatinic acid with a concentration of 1000 mg/100 mL as a precursor, the sample is successfully loaded with 1.2% Pt under full-spectrum test conditions and illumination for 30 min. Then 10 mmol/L ascorbic acid is added to the above solution and stirred, when the ascorbic acid is fully dissolved, the hydrogen desorption experiment is started. The photoreactor containing the solution is assembled on a gas phase device, the reaction temperature is maintained at 5° C. and the reaction time is 2 h, after the reaction, the gas is measured by gas chromatography, finally, H₂ generation is detected, and the final experimental results are shown in FIG. 1C.

What is claimed is:

1. A high-entropy covalent organic framework compound, wherein a structural formula of the high-entropy covalent organic framework compound is selected from one of the following formulas:

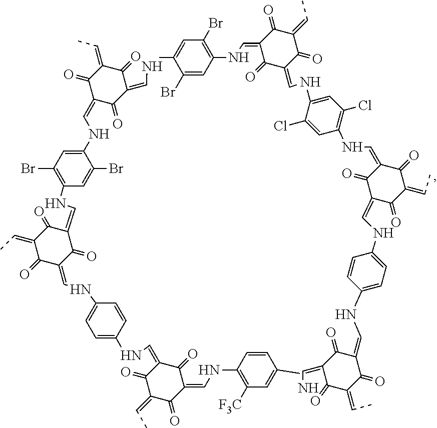

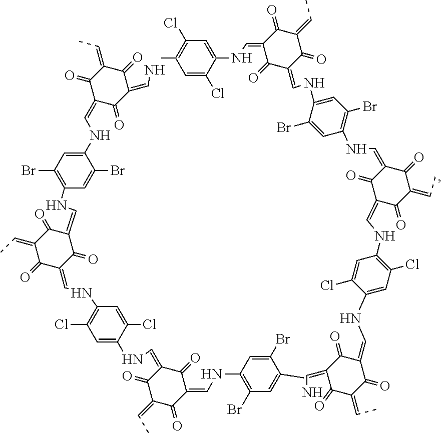

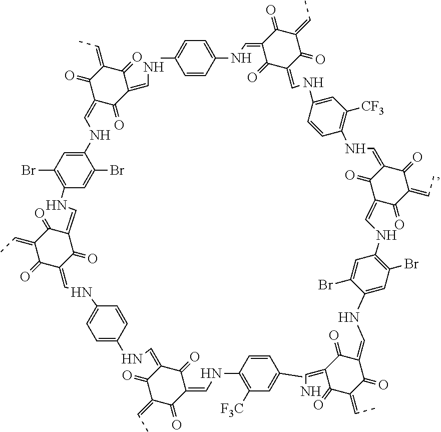

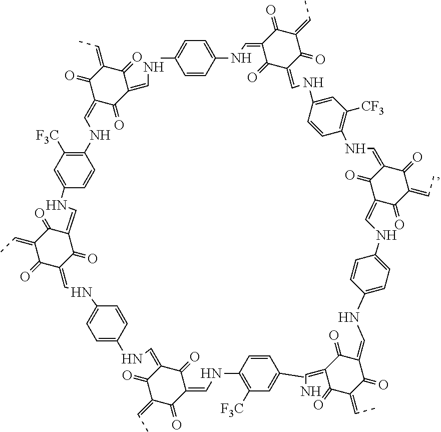

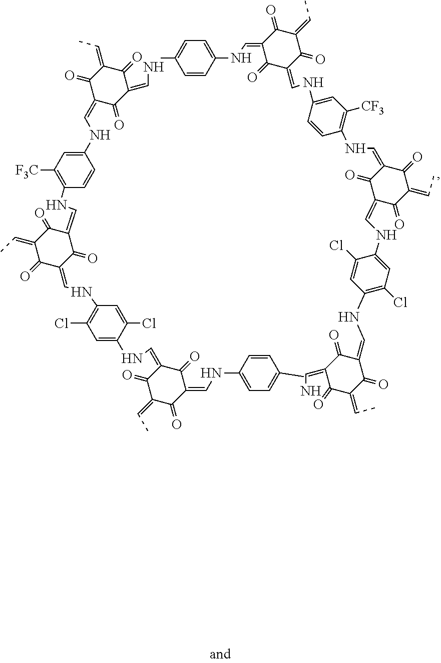

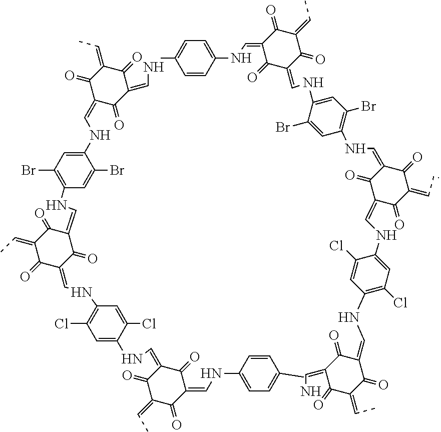

2. The high-entropy covalent organic framework compound according to claim 1, wherein in an X-ray powder diffraction pattern of the high-entropy covalent organic framework compound, 2θ of the high-entropy covalent organic framework compound comprises characteristic peaks at 2.88°±0.1, 5°±0.1, 5.7°±0.1, 7.5°±0.1, 10°±0.1, 25°±0.1, corresponding to (100), (110), (200), (210), (220), (001) crystal planes.

3. A preparation method of the high-entropy covalent organic framework compound according to claim 1, comprising the following steps:
(1) adding trialdehyde phloroglucinol and phenylenediamine monomers to a reactor, adding a solvent, and performing an ultrasound treatment on a resulting mixture to make the trialdehyde phloroglucinol and the phenylenediamine monomers fully dispersed in the solvent; and
(2) adding an acetic acid solution with a mass concentration of 10%-30% into a sample obtained in step (1), performing the ultrasound treatment on the sample to make the acetic acid solution evenly be dispersed to obtain a resulting solution, vacuuming the resulting solution in an atmosphere of liquid nitrogen, and sealing a vacuum flame of the reactor under a condition of vacuuming, subsequently, reacting at 80° C.-150° C. for 1-7 d.

4. The preparation method of the high-entropy covalent organic framework compound according to claim 3, wherein the phenylenediamine monomers described in step (1) are 2,5-dibromo-p-phenylenediamine, 2,5-dichloro-p-phenylenediamine, 2-(trifluoromethyl)-1,4-phenylenediamine, and para-phenylenediamine;
a molar ratio of an aldehyde group to an amino group is controlled at (1-5):1 in the trialdehyde phloroglucinol and the phenylenediamine monomers; and
a molar ratio of the 2,5-dibromo-p-phenylenediamine, the 2,5-dichloro-p-phenylenediamine, the 2-(trifluoromethyl)-1,4-phenylenediamine, and the para-phenylenediamine of the phenylenediamine monomers is (1-2):(1-2):(1-2):(1-2).

5. The preparation method of the high-entropy covalent organic framework compound according to claim 3, wherein the solvent described in step (1) is a mixed solvent formed by o-dichlorobenzene and an alcohol of C1-C5, and a volume ratio of the o-dichlorobenzene to the alcohol of C1-C5 is 1:(0.5-5).

6. The preparation method of the high-entropy covalent organic framework compound according to claim 3, wherein in step (1), a concentration of each of the trialdehyde phloroglucinol, the 2,5-dibromo-p-phenylenediamine, the 2,5-dichloro-p-phenylenediamine, the 2-(trifluoromethyl)-1,4-phenylenediamine, and the para-phenylenediamine is 0.01 mmol/mL-0.1 mmol/mL.

7. The preparation method of the high-entropy covalent organic framework compound according to claim 6, wherein in step (1), the concentration of each of the trialdehyde phloroglucinol, the 2,5-dibromo-p-phenylenediamine, the 2,5-dichloro-p-phenylenediamine, the 2-(trifluoromethyl)-1,4-phenylenediamine, and the para-phenylenediamine is 0.03 mmol/mL-0.04 mmol/mL.

8. The preparation method of the high-entropy covalent organic framework compound according to claim 6, wherein in step (2), a pH of the sample is adjusted by the acetic acid solution before vacuuming in the atmosphere of liquid nitrogen; a mass concentration of the acetic acid solution is 10-30%, and a pH condition range is 2.26-2.02; and
in step (2), the sample is frozen-thawed several times before sealing the vacuum flame.

9. The preparation method of the high-entropy covalent organic framework compound according to claim 3, wherein the high-entropy covalent organic framework comprises halogen elements F, Cl, Br, and percentages of C, N, O, F, Cl, and Br are 15%-25%, 10%-20%, 35%-45%, 10%-20%, 5%-10%, 5%-10%, respectively.

10. A method of a use of the high-entropy covalent organic framework compound prepared by the preparation method according to claim 3 as a photocatalytic reagent for water splitting to resolve hydrogen, comprising: loading 1.0-1.3% Pt with ascorbic acid as a sacrificial reagent on the high-entropy covalent organic framework compound prior to the use.

11. The method according to claim 10, wherein in the preparation method, the phenylenediamine monomers described in step (1) are 2,5-dibromo-p-phenylenediamine, 2,5-dichloro-p-phenylenediamine, 2-(trifluoromethyl)-1,4-phenylenediamine, and para-phenylenediamine;
a molar ratio of an aldehyde group to an amino group is controlled at (1-5):1 in the trialdehyde phloroglucinol and the phenylenediamine monomers; and
a molar ratio of the 2,5-dibromo-p-phenylenediamine, the 2,5-dichloro-p-phenylenediamine, the 2-(trifluoromethyl)-1,4-phenylenediamine, and the para-phenylenediamine of the phenylenediamine monomers is (1-2):(1-2):(1-2):(1-2).

12. The method according to claim 10, wherein in the preparation method, the solvent described in step (1) is a mixed solvent formed by o-dichlorobenzene and an alcohol of C1-C5, and a volume ratio of the o-dichlorobenzene to the alcohol of C1-C5 is 1:(0.5-5).

13. The method according to claim 10, wherein in step (1) of the preparation method, a concentration of each of the trialdehyde phloroglucinol, the 2,5-dibromo-p-phenylenediamine, the 2,5-dichloro-p-phenylenediamine, the 2-(trifluoromethyl)-1,4-phenylenediamine, and the para-phenylenediamine is 0.01 mmol/mL-0.1 mmol/mL.

14. The method according to claim 13, wherein in step (1) of the preparation method, the concentration of each of the trialdehyde phloroglucinol, the 2,5-dibromo-p-phenylenediamine, the 2,5-dichloro-p-phenylenediamine, the 2-(trifluoromethyl)-1,4-phenylenediamine, and the para-phenylenediamine is 0.03 mmol/mL-0.04 mmol/mL.

15. The method according to claim 13, wherein in step (2) of the preparation method, a pH of the sample is adjusted by the acetic acid solution before vacuuming in the atmosphere of liquid nitrogen; a mass concentration of the acetic acid solution is 10-30%, and a pH condition range is 2.26-2.02; and
in step (2) of the preparation method, the sample is frozen-thawed several times before sealing the vacuum flame.

16. The method according to claim 10, wherein the high-entropy covalent organic framework prepared by the preparation method comprises halogen elements F, Cl, Br, and percentages of C, N, O, F, Cl, and Br are 15%-25%, 10%-20%, 35%-45%, 10%-20%, 5%-10%, 5%-10%, respectively.
